(19) United States
(12) Patent Application Publication
(10) Pub. No.: US 2009/0151292 A1
(43) Pub. Date: Jun. 18, 2009

(54) Building block and system for manufacture

(76) Inventor: Robert F. Sinclair, SR., Treasure Island, FL (US)

Correspondence Address: Paul M. Denk, 763 South New Ballas Road, Suite 170, St. Louis, MO, 63141, US

(21) Appl. No.: 12/378,428

(22) Filed: Feb. 17, 2009

Related U.S. Application Data
(63) Continuation of application No. 11/238,934, filed on Sep. 29, 2005.
Application No. 11/238,934 is a continuation-in-part of application No. 10/815,533, filed on Apr. 1, 2004, now abandoned.

(51) Int. Cl. E04C 1/40; C04B 20/00

(52) U.S. Cl. 52/596; 106/674

(57) ABSTRACT

A compressed building block formed of a pre-mix of fly ash, either of the Class C type, is combined with either ground or pulverized wood chips, or with fine sand, and a plasticizer, and accelerator, then moisturized, and lastly either extruded or compressed in a mold into the configuration of a block. The block lacks a binder, except Portland cement for select military applications. A mold retardant may be added to the mixture, to provide the formed block with further beneficial attributes. The blocks may be formed by a system for extruding such blocks from the formulation, or they may be formed by means of a hydraulic or other press and pressed into the configuration of the desired block, needed for the construction.

### CROSS-REFERENCE TO RELATED APPLICATIONS

This continuation application for patent claims priority to the continuation-in-part application having Ser. No. 11/238,934, which was filed on Sep. 29, 2005; which claims priority to the continuation-in-part application having Ser. No. 10/815,533, which was filed on Apr. 1, 2004, abandoned; which claims priority to the non-provisional patent application having Ser. No. 10/411,551, which was filed Apr. 10, 2003, abandoned; which claims priority to the provisional patent application having Ser. No. 60/371,441, which was filed on Apr. 11, 2002, and is owned by a common assignee.

### BACKGROUND OF THE INVENTION

This invention relates principally to a building block, one that is constructed, generally of waste material, such as fly ash, and can be either extruded or compressed under pressure into the fabrication of a building block for constructing buildings or the like.

There are numerous building blocks that are available in the art for use for the construction primarily of commercial industrial type of buildings, and even some blocks are used for constructing residential homes, as known. For example, most of these blocks are fabricated from concrete, poured into a form, left to cure, and then removed and allowed to dry, in preparation for usage. Blocks of this type, generally of concrete, can be formed in a variety of shapes.

Various prior art types of blocks, usually of the molded type, can be seen in the prior patent to Haener, U.S. Pat. No. 5,822,939, identified as An Insulated Building Block System. The patent to Putnam, U.S. Pat. No. 2,319,345, discloses another type of Fabricated Building Block. The patent to Crespo, U.S. Pat. No. 4,514,949, shows an Interlocking System for Building Walls, and it should particularly be noted that the shown block includes openings, and through which reinforcing rods may locate, during building construction. The patent to Schmall, U.S. Pat. No. 513,423, discloses another form of Building Block. The patent to Sherwood, U.S. Pat. No. 5,715,635, discloses a Building Block Unit and Method of Manufacturing the Same. This includes an interlocking type of feature that can hold the blocks together, even perhaps without connecting mortar. The patent to Stenekes, U.S. Pat. No. 6,065,265, shows A Corner and End Block for Interlocking Building Blocks System.

The patent to Hancock, U.S. Pat. No. 3,355,849, shows a Building Wall and Tapered Interfitting Blocks Therefore. Another patent to Hancock, U.S. Pat. No. 3,936,989, shows an Interlocking Building Type of Block That Can Be Fabricated into a Wall System, even perhaps with or without the use of mortar. U.S. Pat. No. 4,126,979, to Hancock, shows another Interlocking Form of Building Block.

The current invention is designed to provide for the construction of a building block, by a variety of methods, but one which does not rely on cement as it utilizes extensively what are currently considered as wood substitutes: wood chips, sawdust, textile waste, and fly ash, among other things.

For example, the U.S. patent to Strabala, U.S. Pat. No. 5,534,058, discloses a structural product fabricated from waste materials, and its method of making the same. The product includes as ingredients fly ash, cellulose-based material, and an adhesive binder for holding these ingredients together. The patent states that the mixture is particularly useful for forming structural products such as bricks, panels, roof shingles, studs, and the like. More specifically, the patent defines that the structural product, which may also be formed into blocks, comprises a substantially homogeneous blend from seventy to eighty-five percent (70 to 85%) by weight of a Class C fly ash, or a mixture of Class C fly ash and Class F fly ash. The mixture further includes about fifteen to thirty percent (15 to 30%) by weight of a cellulose based material, which can be pulp, wood, sawdust, pulverized cardboard, or the like. The block further includes an adhesive binder, which is categorized as an emulsion, even one which can be mixed with water to form a liquid. Preferably the adhesive binder is polyvinyl acetate, which can be added to the mixture as an emulsion. The mixture also includes an inner filler, and such material may include lime, Class F fly ash, or bottom ash, up to about thirty-five percent (35%) by weight of the total weight of the mixture.

The current invention likewise utilizes a fly ash as a primary ingredient, but varies substantially from what is identified in the Strabala patent, utilizing either a molding or pressure application to form its composite blocks, for use for a related purpose: construction.

Other prior art patents identifying the use of fly ash, as an ingredient for forming insulating and ceramic materials, and the like, include the patent to Sicka, U.S. Pat. No. 3,625,723, for Foamed Ceramic Comprising Fly Ash and Phosphoric Acid. U.S. Pat. No. 1,608,562, to Melandri, defines the Manufacture of Building Blocks, Slabs, Floors, Ceilings, Tiles, and the Like, from a mixture of fibers and cementous material, and hydrated lime. The patent to Halwani, U.S. Pat. No. 5,504,211, describes a Lightweight Block Containing Stabilized Wood Aggregates. The patent to Riddle, U.S. Pat. No. 5,366,548, explains the use of Volcanic Fly Ash and Kiln Dust Mixtures, and a Process for Making Articles Therefrom. The patent to Patterson, U.S. Pat. No. 5,350,451, explains a Building Material Made From Waste Paper and a Method for Producing the Same. The patent to Wada, et al., U.S. Pat. No. 5,154,771, explains a Hydraulic Inorganic Mixture and Molded Articles Thereof. The patent to Lempfer, et al., U.S. Pat. No. 5,102,596, explains the Method of Producing Shaped Articles of Fiber/Binder Mixtures. The patent to Elias, U.S. Pat. No. 5,048,250, shows another type of Building Block. The patent to Vinson, et al., U.S. Pat. No. 4,985,119, shows a Cellulose Fiber-Reinforced Structure. The patent to Baes, U.S. Pat. No. 4,840,672, explains that Lightweight Insulating Boards and Process for Manufacturing the Same. The patent to Costopoulos, et al., U.S. Pat. No. 4,659,385, shows a Building Material Manufacturing from Fly Ash. The patent to Barrable, U.S. Pat. No. 4,132,555, explains a Building Board. Finally, and lastly, the patent to Nutt, U.S. Pat. No. 3,753,749, shows other Concrete Mixtures.

### SUMMARY OF THE INVENTION

This invention relates primarily to the construction of a unique building block, one fabricated totally from waste materials and without a binding agent, and a number of systems by which the block may be fabricated and molded, into a high strength finished product. This invention contemplates three aspects relating to its concept: initially, the formulation and type of building block constructed, and two methods or systems by which the block may be fabricated, in preparation for usage.

Essentially, the building block of this invention can be fabricated of the open cavity type, but preferably, is constructed into the configuration of a solid block, thereby providing it with greater strength and less susceptible to fracture, because of the solid integrated nature of its construction. Because of the type of waste materials from which the block is fabricated, including wood pulp, or the like, the block will accept and hold a nail, screw, or the like, so that supplemental sheeting, rather exteriorly or interiorly, can be applied and held directly to it, during fabrication of a building. Furthermore, because of the inherent nature of its ingredients, it can also be subject to cutting by a power saw, or the like. In addition, the block of this invention, because of its mixture, has enhanced thermal resistant characteristics, as can be understood. In addition, it can be treated, with other ingredients, such as a boride, to render it termite and mold resistant. It can function as a sound insulation; even can be used as a sound wall in or near high-noise areas, like at airports and industrial parks, and as dividing walls for adjacent condominiums and apartments, to provide that type of insulation.

Significantly, the block of this invention has high strength and a large load bearing capacity due to its solid configuration, and obviously provides safety during usage, lowers energy bills, and as previously alluded to, is fabricated from generally waste ingredients, meaning that it will be low cost in construction. The block is made generally of about ninety-nine percent (99%) waste materials, and therefore, is earth-friendly as a “green” building material, as can be understood.

In the preferred embodiment, the block may be constructed having dimensions generally in the category of nine and one-half inches high, eight inches deep, and seventeen and one-half inches wide (9.5″×8″×17.5″) including the tongue and groove jointed edges. Obviously, other dimensions can be readily applied during fabrication of the blocks of this invention.

Generally, the formulae for the compressed or extruded blocks of this invention are designed to provide maximum usage of waste material, such as fly ash, as known in the art, without cement or other binder. For example, where it is desired to fabricate a block having dimensions generally within the range of nine and one-half inches by eight inches, and to any length (9.5″×8″×any length), depending upon the mold, it will include a Class C Fly ash in a range of about fifty percent (50%) to ninety percent (90%) by weight of the formulated block. Wood pieces or cellulose materials, such as chips or chunks, may be applied in the vicinity of ten percent (10%) to fifty percent (50%) by weight of the mixed formulation. Optionally, boron, or a boride, may be added in the range of one-half percent to five percent (½% to 5%), in order to furnish the mold retardancy and as a preventer of insect infestation, characteristics which are desirable particularly since the formulation of this invention includes ground wood ingredients, as previously explained. Class C fly ash is readily available in abundance from the many coal fired electric generating plants. In an alternate embodiment for the military, Portland cement may be added in a range of about two percent to twenty percent (2% to 20%), for ballistic or hardening purposes.

Other ingredients that may be used effectively in addition to fly ash include wood, wood ash, sugar beat waste lime, rice straw, wheat straw, cotton stalks, sugar cane, bamboo, sea shells, sand, river sand, quarry sand, and desert sand, all of which may be used as wood substitutes, to add further strength to the mixture, from between ten percent (10%) to thirty percent (30%) by weight, thereby reducing the amount of fly ash that may be necessary in the mixture, or for reducing the wood chip ingredient, in order to provide enhanced strength to the blocks, when formed, as can be understood. Obviously, the greater the quantity of sand or other granular material that is added to the block, reduces the wood pulp content, makes the block less isolative, and reduces the ability of the finished block to accept and hold a nail and a screw, when applied during the construction of a building.

Two other essential ingredients for the mixture for forming the building block of this invention includes the addition of a Plasticizer agent to the composition, during its mixing, for the purpose of providing a dispersion of the mixed components within the ingredients, including water, that results in a more thorough mix of the ingredients, and allows for their better flow ability, during the deposit of the formal into the forms. In addition, an accelerator is useful for re-acting the fine particles of the mixture with all of the other ingredients, during mixing, so as to more quickly and better form the slurry for addition to the forms, during molding of the blocks.

The system of manufacturing the blocks of this invention includes the extruding method, which incorporates a cyclone wood chip hopper, into which the chips may be placed, and in which hopper the fly ash from an outside silo may be delivered, to provide for the proper mixing. A variable speed feeder may be used to deliver the mixture to a pre-mixer, wherein treated water may be added, and a displacement compressor provides the necessary pressure on the mixture, as it is delivered to a variable speed extruder, that may extrude a continuous block, to desired cross sectional dimensions, such as nine and one-half inches by eight inches (9.5″×8″), but to any length. Such lengths may even be as great as four feet to sixteen feet long (4′ to 16′), for the extruded block, exiting from the extruder. The block may then be conveyed to another location for drying, curing, and storage, before it is shipped to the building site, for usage.

The preparation of the compressed block may be achieved through the usage of a hydraulic press, which exerts a ram force upon the block ingredients, delivered to the site of compression, where the blocks are instantly formed under modest pressure, into individual blocks, to dimensions as desired, and then exit the compression chamber by way of a conveyer, to a remote location for further drying and curing, or for storage until usage. The type of modified hydraulic press, that has found usage for the purposes of building the blocks of this invention, may be obtained from Vermeer Manufacturing Company, of Pella, Iowa, or a related type of hydraulic or other press.

It is, therefore, the principle object of this invention is to provide a unique building block that can be instantly manufactured for low cost from generally waste ingredients and materials.

Another object of this invention is to provide a molded, even one constructed under pressure, building block to a variety of dimensions, at the selection of the builder, and the owner.

Yet another object of this invention is to provide a building block that has retention attributes, and can hold a nail or screw, upon application.

Still another object of this invention is to provide a building block that may be fabricated having various grooves, in order to allow the locating of reinforcing bars, utility conduits, or the like.

Still another object of this invention is to provide a building block having a solid surface, and not necessarily made of the cavity type prior art block, and therefore exhibits a much larger load-bearing capacity than other type of fabricated blocks.

Still another object of this invention is to provide a building block that has a high fire resistance rating.

Another object of this invention provides a building block that will be insect and termite resistant because wood is a major ingredient, as organic inhibitors or coatings provide high resistance to insect infestation.

Still another object of this invention is to provide a building block having a high wood chip and piece content.

Another object of this invention is to provide a building block that may be held together without cement or other pozzolans, and does not necessarily require the usage of any mortar as normally used and required between blocks in typical applications.

Another object of this invention is to provide a building block that exhibits thermal insulation value in the range of R-16, and higher.

Still another object of this invention provides a building block that has excellent noise suppression benefits.

Yet another object of this invention is to provide a building block that eliminates the need for the stud-wall framing, and insulation batting. This can be achieved, because the building block already has good thermal insulation, and its wood content allows the builders to nail or screw the exterior and interior sheeting and other framing members, directly to the manufactured wall.

Another object of this invention is to provide a building block for use for constructing walls, which in certain jurisdictions, are already approved for general building usage.

Another primary object of this invention is to provide a sustainable building product, being composed primarily of waste materials. Hence, it provides a method by which waste material may be disposed of and utilized, without filling the landfills, with such waste material. For example, agricultural waste, logging waste, or even broken or waste wood pallets which can be chipped, can be used for the purpose of fabricating the blocks of this invention.

Another object of this invention is to have an appearance that does not reveal the ingredients used in the invention.

Another object of this invention is to form a block without any adhesive material mixed therein.

Another object of this invention is to improve the hydration of the mixture which results in a faster and more thorough chemical reaction of the components of the present invention.

These and other objects may become more apparent to those skilled in the art upon review of the invention as described herein, and upon undertaking a study of the description of its preferred embodiment, when viewed in conjunction with the drawings.

### BRIEF DESCRIPTION OF THE DRAWINGS

In referring to the drawings,

FIG. 1 provides an isometric view of the fabricated building block of this invention;

FIG. 2 is a schematic view of the system for processing by compression of the building blocks of this invention; and

FIG. 3 is a schematic view of a portable hydraulic press utilized occasionally for the pressure forming of the blocks of this invention.

The same reference numerals refer to the same parts throughout the various figures.

### DESCRIPTION OF THE PREFERRED EMBODIMENT

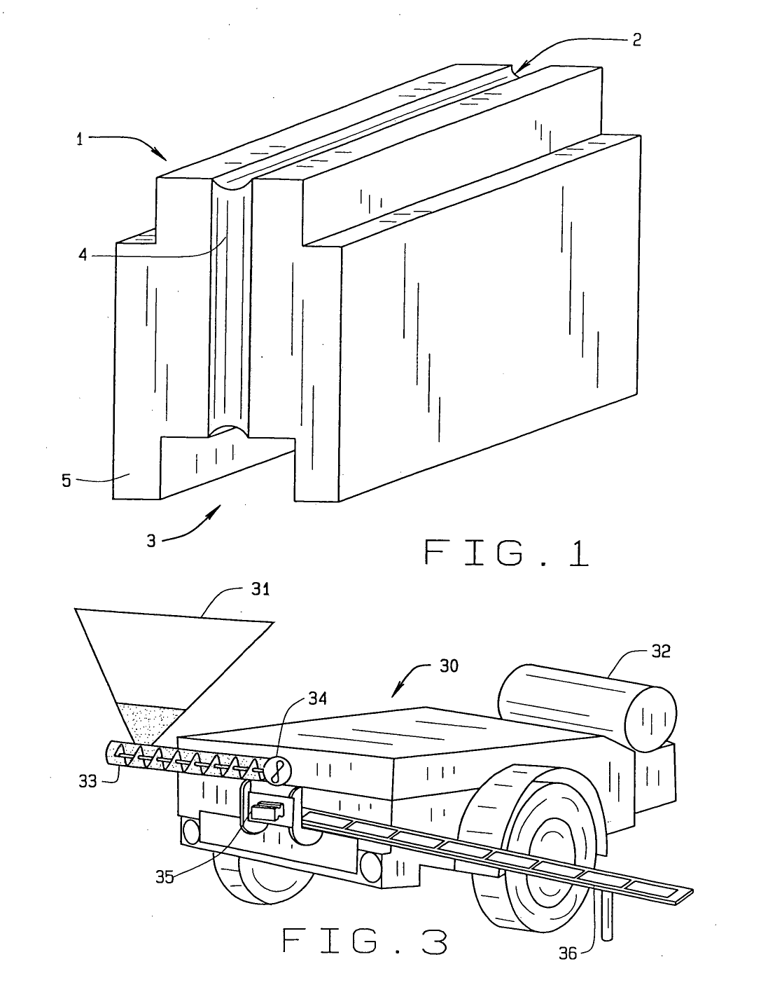

In referring to the drawings, and in particular FIG. 1, the example of the type of building block fabricated by the system of this invention is readily disclosed. The building block 1 will be of standard shape or appearance, but can be fabricated to any size, but generally may be in the range of four inches high, eight inches wide, and twelve inches in length (4″×8″×12″), but preferably nine and one-half inches high, eight inches wide, and seventeen and one-half inches in length (9½″×8″×17½″). Obviously, other dimensions may be used for the block of this invention, and depending upon which system is used to fabricate the blocks, as for example, in the extruded block, a block of any length, such as sixteen feet (16′) as previously stated, could be developed. Or, where the block is molded by hydraulic pressure, it may have a shape and proportions similar to those as shown in FIG. 1. In addition, the block may be molded or extruded having supplemental configurations, such as the upper tongue 2 and lower groove 3, and end grooves 4, as noted. Preferably, the legs 5 will be greater than two inches (2″) each to provide structural strength to the areas of the block. The purpose of these grooves is to provide clearance, either for locating reinforcing bars or perhaps conduits that may extend through the wall and through which electrical wires, heating ducts or other types of utilities may be located. The preferred embodiment has a chamfered and protruding top or tongue and a matching bottom or groove.

The formulation for the block of this invention can be seen from the tables hereinafter provided.

TABLE I

Extruded industrial blocks 9.5″ × 8″ × any length
Class C fly ash from 50% to about 90%
Ground wood from 10% to 50%
Boron from ½% to about 5%

TABLE II

Compressed industrial blocks 9.5″ × 8″ × 17.5″
Class C fly ash from 50% to 90%
Portland cement 2% to about 20%
Ground wood from 10% to about 50%
Boron from ½% to about 5%, or

TABLE III

Compressed industrial blocks 9.5″ × 8″ × 17.5″
Class C fly ash from 50% to about 90%
Ground wood from 10% to about 50%
Boron from ½% to about 5%

Water is applied in all these formulations from fifteen percent (15%) up to twenty-five percent (25%).

Plasticizer or water reducer is added to each of these tables approximately one-half ounce (0.5 oz.) to thirty ounces (30 oz.) per hundredweight of fly ash in the mixture.

Accelerator is added to each of these tables approximately zero (0) to approximately thirty-two ounces (32 oz.) per hundredweight of fly ash in the mixture.

These formulae are supplemented by a plasticizing or a water reducing agent, and an accelerating agent. A plasticizer increases the slump of the mixture and raises the viscosity of the mixture which improves the flow characteristics of the material, generally at low water levels in the mixture. Plasticizers such as preferably PLP from W.R. Grace & Co. of Cambridge, Mass., and alternatively Sika 6100 from Sika Corp. of Marion, Ohio, Melchem from General Resource Technology, Inc. of Eagan, Minn., and Polyheed FC100 from Master Builders, Inc. of Cleveland, Ohio, have also shown a water replacement capability. Generally, the plasticizer provides for heightened dispersion of the mix components within the water resulting in a smooth faced block formed under pressure. More particularly, the plasticizer acts as a hydration agent or a wetting agent that mixes the components more thoroughly, thus reducing the incidence of the mixture balling. The plasticizer improves the ability of water to coat the surfaces of the solid components of the mix on the micro level. On the macro level, the resulting blocks do not reflect on their outside the chunky appearance of the aggregate or other mix components. Rather, the blocks take on the shape and surface texture of their forming chamber.

A water reducing agent disperses the fine particles of the mixture with less water. The agent enhances the effect of water throughout the mixture. The formulation is made into blocks with less gallons of water per hundredweight of formulation. Lessening the water requirement saves on weight and labor costs during fabrication of blocks. Water reducers such as preferably FC100 from MasterBuilders, and alternately Sika 6100 from Sika have readily reduced the water required in mixtures.

An accelerator makes the reaction of fine particles with the remainder of the mixture occur more quickly. The mixture solidifies at higher strength more quickly. An accelerator is also useful for low temperature casting where the accelerator augments ambient temperature and returns curing to normal duration from the cold delayed duration. Accelerators such as preferably RAPID-1 from Sika, and alternatively Pozzolith from Master Builders and Polychem Super Set from General Resource Technologies provide for increased strength once the mixture cures.

The co-action of the plasticizer and the accelerator improve the chemical reaction of the components within the mixture. The chemical reaction occurs faster and a greater amount of the components are reacted while a lower percentage of the components are wasted through non-reaction. Further, these formulae lack a binding agent, except Portland cement for the military formula, and thus the actions of the plasticizer, water reducer, and accelerator upon the mixture, under forming pressure, make a consistent and strong block.

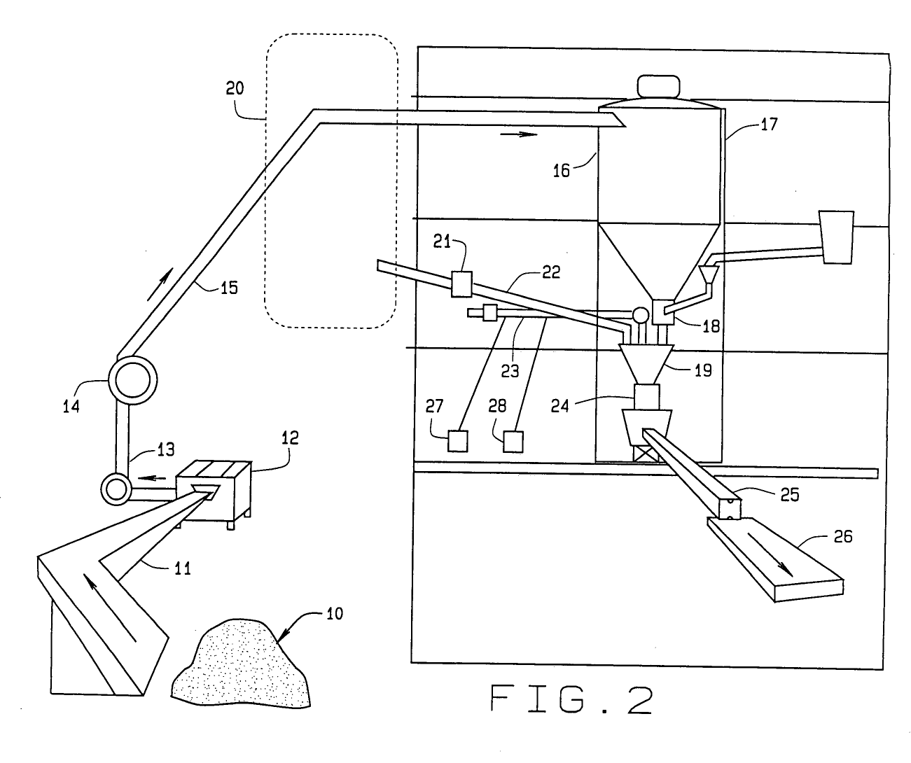

As can be seen from FIG. 2, the system for pressing the industrial building blocks of this invention is readily disclosed. As noted, the ingredients for the block are processed by the system, as disclosed. For example, pre-ground wood chips, as at 10, are delivered by conveyor 11, to a hammer mill 12, to provide a secondary grinding or pulverizing of the chips. The ground and pulverized wood will be conveyed by a blower 13, to a roto-paddle blower 14, and delivered by conduit tubing 15, for emitting into the upper end of a cyclone wood chip hopper 16, as can be noted. Support structure, as at 17, provides the bracing necessary for structurally holding the system in place.

From the cyclone wood chip hopper, the ground pulp, which may include wood chips, textile waste, bamboo, rice straw, wheat straw, or any other pulp ingredients, are delivered to a variable speed roto-feeder, as at 18. Then the proper amount of the wood ingredient is delivered to a pre-mixer 19, as noted. At this point, and into the pre-mixer, fly ash from an outside silo source 20 is delivered by way of a variable speed auger 21, through a conduit 22, to the pre-mixer. The fly ash may be generated and deposited into the silo from any of the sources for this ingredient. For example, it may be the fly ash from power plants or other installations.

In addition to the delivery of the wood chip component, and the fly ash from external sources, water, by way of the conduit 23, is also metered into the pre-mixer, to provide some degree of texture that renders the mixture more pliable, and capable of being either extruded, or compressed, as can be understood. A plasticizer 27 and an accelerator 28 are pumped into the mixture for blending with the other ingredients. The amount of the ingredients added, including the treated water, plasticizer, and accelerator, can be determined from the formulations as previously set forth.

From the pre-mixture, a variable speed mixer further mixes the ingredients, as at 24, and delivers it to a variable speed or hydraulic press 25. At this point the blocks will then be conveyed upon the conveyor 26, to a location of drying, curing, storage, or even for use for installation at a building site.

As an example of usage of the hydraulic press process, utilizing the system as shown in FIG. 2, the raw feed stock, such as shredded wood, will be delivered to the plant site, which may be arranged at a landfill location. The wood chips are moved from the receiving hopper via the belt conveyor, as explained, to a hammer mill, where it is ground into small pieces. From there the wood is carried by an air stream to a cyclone, for the purpose of separating the wood from the air, where the wood particles then fall into the hopper. There it is fed via a variable speed auger to a continuous flow mixer, identified as the variable speed mixer.

Fly ash, such as Class C fly ash, is delivered by bulk truck, to the silo at the plant where the blocks are formed. The fly ash is carried by another mixer, by way of a variable speed auger during the process. The fly ash is generally obtained from coal burning power plants, and delivered in bulk to the silo where it is then delivered to the variable speed auger. In an alternate embodiment for the military, Portland cement by bulk trucks is also provided, in a variation on the formulae, to another silo, where it likewise may be added as an ingredient by a variable speed auger. The alternate embodiment also has a dispersant agent such as Ultra from W.R. Grace or Rheomix from Master Builders that spreads the cement throughout the mixture for even and thorough reaction.

In the preferred embodiment, calcium borate is delivered to the plant, and is likewise moved to the mixer by way of a variable speed auger. Obviously, the variable speed augers are all used to provide for the delivery of the precise amount of the ingredients, as determined necessary, for formulating the type of blocks to be molded or cast. Ground wood is delivered to the processing plant in bulk trailers. It is blended with ground wood, to provide further bulk. Treated water is injected into the mix blend just before it exits the mixer, on its way to the press. The hydraulic press forces the slurry through a dye, as in the preferred embodiment, yielding a nine and one-half inch by eight inch by seventeen and one-half inch (9.5″×8″×17.5″) block.

The second method for fabricating the blocks of this invention may be seen from FIG. 3, which shows a modification to a hydraulic press, which is utilized to compression form the blocks, under hydraulic pressure, although other sources of pressure may be utilized.

The system for providing a hydraulic or other pressured compression for forming the compressed block of this invention is shown in FIG. 3. As disclosed, this may be a more portable device. It includes the hydraulic ram machinery, such as shown at 30, which is a device for providing pressure to a ram, generally under hydraulic pressure, and is available, as previously explained, from Vermeer Manufacturing Company, of Pella, Iowa. This particular hydraulic ram machinery includes a feed hopper 31, into which the blended mix of material may be inserted, and is injected with some water from the liquid tank 32, the mix being delivered from the hopper by way of an auger conveyor 33, to a blender mixer 34, as noted. At this location, the mix is completely blended, and then in dosages delivered to the compression chamber 35 where the hydraulic ram exerts significant pressure, up to two thousand two hundred sixty-five pounds per square inch (2265 psi), upon the mixture, to compress the material into a solid and uniform block, having the configuration designed from the mold provided within the compression chamber, to shape the style of block desired. At this point, when the hydraulic pressure is eased, the blocks are delivered along a conveyor 36, where the blocks can be stacked upon skids, pallets, or the like, and then left to stand for drying and curing. Following this, the blocks can be either stored or shipped for usage.

During the delivery of the material to the hopper 31, a laborer will generally be emptying bags of the pre-mixed powder containing material relating to the formulation as defined in Table II, which may be modified or varied with any of the other type of waste fly ash, such as that derived from sugar beet waste lime, of Table III, or have some of the sand provided therein, as analyzed in Table V.

In the formation of the blocks from the hydraulic or other pressure compressed blocks, the material will be formed similar in the manner as the pre-mix for the extruding process, including the delivery of the ground wood to the plant, for mixing, as previously explained. The material from the mixer, in the extruding process of FIG. 2, will be left dry, and bagged, for delivery to the feed hopper 31, of the Vermeer Block Press.

Generally, the same formula is used as in the extruding process, but in the high pressure press, other blends will also work because of the pressure involved, up to three thousand pounds per square inch (3000 psi), which is further effective in forming the desired block.

It is likely that a blend of the sugar beet waste lime could be employed in the hydraulic pressing process, with a blend of an approximately twenty-five percent (25%) by weight of the sugar beet waste lime, and seventy-five percent (75%) by weight of class C fly ash. The pre-mix is added to the feed hopper 31, with a blender 34, built into it. A twelve volt marine type pump delivers treated water to the mixture. This makes the press totally self contained and portable because the hydraulic press mounts directly upon the trailer frame. Once the hydraulic engine is turned on, the pre-mix is poured into the feed hopper, delivered to the blender; some moisture is added, generally in the amount to make a substantially viscous pre-mix. The press is then applied, after a batch of the materials is deposited into the mold, at the compression chamber, for immediately forming a hard block. A spray system may be used for adding the water at the blender/mixer, and the water tank assembly holds approximately one hundred gallons of water. The compression chamber, at the mold, may include a weighing device, to ensure that the proper amount of materials is added into the mold, before compression is initiated. The mold may also be constructed in a manner to provide the shape the block is desired, as for example, the mold may contain the semi circular protrusions, in order to form the tongues 2 and grooves 3, and the end grooves 4, within the finished block, when compressed.

In actual practice, the compressed blocks, formed by the hydraulic press of this invention, are achieved as follows. The dry pre-mixed product, that which has been bagged at the mixer 24 in the extruding process, may be packaged in either ninety pound (90 lb) bags or two thousand three hundred and fifty pound (2350 lb) super sacks. The contractor may have the product delivered to the job site, or have it collected at the mixing plant. Part of the contractor's equipment will require the usage of a large truck to haul the product, and to pull the block press 30 with it.

The first step the operator does is to check the fluid levels in the engine and hydraulic reverse tanks. Second, the engine is started, and warmed up. Third, the operator selects either the manual or automatic setting. The manual setting is used with the ninety pound (90 lb) bags, while the automatic setting is used with the super sacks. In either case, the powder is fed into the feed hopper 31. From there, the material is fed into the blender by way of the auger 33. It then falls by gravity into the open compression chamber, where the mold is provided. Water is blended with the powder as it passes down through the blender. The compression cylinder is activated, either manually by the operator, or by press controls. The pressure varies from three hundred to three thousand pounds per square inch (300 to 3000 lbs psi), as explained. When the pressure reaches the operator pre-set level, a second hydraulic cylinder, built into the machine, and arranged at a right angle at the rear of the compression chamber activates, pushing the compressed block out of the side ramp, onto the conveyor. Now, both cylinders retract, thus opening the compression chamber for more product from the blender. The cycle repeats, and each new block is pushed from the processor further onto the conveyor or ramp, for stacking onto a skid, or the like.

Variations or modifications to the subject matter of this invention may occur to those skilled in the art upon reviewing the disclosure as provided herein. Such variations, if within the spirit of this development, are intended to be encompassed within the scope of the invention as described herein. The description of the preferred embodiment, and as shown in the drawings and schematics, is set forth for illustrative purposes only.

I claim:

1. The construction of a building block, one manufactured substantially from waste materials by molding or extruding into a high-strength and multiple-sided integrated block, said block having a formulation of ingredients, including:
class C fly ash in a range of about fifty percent (50%) to about ninety percent (90%) by weight of the molded block;
ground cellulostic material including wood chunks, wood shavings, wood chips, and textile by-products, mixed in the formulation between about ten percent (10%) to fifty percent (50%) by weight of the mixed formulation;
water added as an ingredient to the formulation between about fifteen percent (15%) to about twenty-five percent (25%) by weight of the formulation;
a plasticizer agent in the range of about one-quarter (0.25) ounce to about thirty (30) ounces by hundredweight of the fly ash in the mixed formulation;
an accelerator agent in the range of about one-half (0.5) ounce to about sixty-four (64) ounces by hundredweight of the fly ash of the mixed formulation; and
introducing the mixed formulation into a compression chamber and subjecting the mixture to significant pressure to compress the formulated material into a solid and uniform block.

2. The building block of claim 1, and including:
boron, added in the range of one-half percent (½%) to five percent (5%) to furnish mold and insect retardancy.

3. The building block of claim 1, wherein the water is sprayed into the molded block in an amount of approximately fifteen percent (15%) to twenty-five percent (25%) by weight of the block formulation.

4. The building block of claim 1, and further comprising:
said plasticizer agent is in the range of about one-half (0.5) ounce to about fifteen (15) ounces by hundredweight of the fly ash in the mixed formulation.

5. The building block of claim 4, and further comprising:
said plasticizer agent is in the range of about one-half (0.5) ounce to about two (2.0) ounces by hundredweight of the fly ash in the mixed formulation.

6. The building block of claim 1, and further comprising:
said accelerator agent in the range of about one-half (0.5) ounce to about thirty-two (32) ounces by hundredweight of the fly ash in the mixed formulation.

7. The building block of claim 6, and further comprising:
said accelerator agent to the range of about one-half (0.5) ounce to about twelve (12) ounces by hundredweight of the fly ash in the mixed formulation.

8. The building block of claim 1, and further comprising:
said plasticizer agent is in the range of about one-half (0.5) ounce to about eight (8.0) ounces by hundredweight of the fly ash in the mixed formulation; and
said accelerator agent in the range of about one-half (0.5) ounce to about twelve (12) ounces by hundredweight of the fly ash in the mixed formulation.

9. The building block of claim 1, wherein said block has dimensions of approximately nine and one-half inches by eight inches by seventeen and one-half inches (9.5″×8″×17.5″) in configuration.
